(19) United States
(12) Patent Application Publication
(10) Pub. No.: US 2006/0119469 A1
(43) Pub. Date: Jun. 8, 2006

(54) User authentication system and room entry/exit management system

(75) Inventors: Takahide Hirai, Tokyo (JP); Koichi Sasakawa, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 11/263,870

(22) Filed: Nov. 2, 2005

(30) Foreign Application Priority Data
Dec. 7, 2004 (JP) 2004-353871

(51) Int. Cl. G05B 19/00; B60R 25/00

(52) U.S. Cl. 340/5.61; 340/5.7

(57) ABSTRACT

A user authentication system of the present invention includes: a first wireless tag having first ID data about a user and a first antenna for transmitting the first ID data; a second wireless tag having second ID data different from the first ID data, and a second antenna, perpendicular to the first antenna, for transmitting the second ID data; a wireless-tag receiver for receiving the first ID data transmitted from the first antenna and the second ID data transmitted from the second antenna; and a use-permission determining apparatus for determining whether the ID data received by the receiver matches pre-registered ID data, and for determining, based on timing of or counts of receptions of the first ID data and the second ID data received during a predetermined period of time, whether use is permitted.

### BACKGROUND OF THE INVENTION

1. Field of the Invention

The present invention relates to user authentication systems, and particularly to a user authentication system in which permission to use a facility is given by the communicating of user ID codes via radio waves. In addition, the invention relates to a room entry/exit management system using such a user authentication system.

2. Description of the Related Art

Conventional user authentication systems include an authentication system that authenticates according to ID codes, using media such as noncontact IC cards that record ID codes (ID data). Typical examples of authentication systems using noncontact IC cards include authentication systems employed for railway automatic ticket gates, room entry/exit management systems, and electronic money. Typical international standards for noncontact IC cards include ISO/IEC14443. The communicable range of noncontact IC cards that meet the standard is about 10 cm. The communicating range is the distance between an IC card held by a user, and a receiving antenna for the authentication system. When the range is around 10 cm, the user has to take hold of the IC card and bring the card close to the receiving antenna for the authentication system to be authenticated.

Meanwhile, communications devices using ID codes that enable long-distance authentication are generally referred to as RFID (radio frequency identification) devices, typical standards for which are ISO/IEC18000-3 and ISO/IEC18000-6. In RFID devices that meet such standards, the communicating range is around 1 meter to 10 meters. An RFID device is generally composed of an RFID tag for transmitting ID codes, and an RFID reader for receiving the ID codes. When the practical communicating range is more than several meters, if the user wears the RFID tag as a nametag, or dangles the tag from the neck, the user can be authenticated based on the ID code recorded in the RFID tag, without special operations for authenticating the user. However, in a case in which the communicating range is several meters, for example, when an RFID device is used in authentication for opening and closing a door, even if the user holding the RFID tag does not intend to come through the door, the ID code might be authenticated merely by the user passing in front of the door, and the door might be opened.

As a technology for solving the problem, there has been a room entry/exit management system including a verification means for verifying transmitted ID codes, and an intention expressing means for the user to express the user's intention to enter/exit the room (for example, see Patent Document 1). More specifically, when an RFID tag is present within the receiving range of an RFID reader, the RFID reader receives the ID code, checks the validity of the ID code, and determines whether entering/exiting the room is permitted. As a consequence of the determination, if entering/exiting the room is permitted, an input from the intention expressing means is awaited for a predetermined time. If an input is received from the intention expressing means within the predetermined time, it is deemed that an intention to enter/exit the room is present, and a door-opening control signal is outputted. If no input is received from the intention expressing means, it is deemed that the intention to enter/exit the room is not present, and the received ID code is discarded.

Patent Document 1: Japanese Laid-open Patent Publication 254050/H08 (Paragraphs 10 through 22, and FIG. 1)

### SUMMARY OF THE INVENTION

In such a conventional user authentication system, even if the communicating range is larger than several meters, and the user's operation is not required for reading ID codes, it has been required to express, using an intention expressing means such as a switch, the intention of use such as entering a room. Therefore, there has been a problem in that, even if an RFID device, in which the communicating range is long, is used, a user is forced to do some operation for authentication, which imposes a burden on the user.

The present invention is made to resolve the problems described above, and aims to provide a user authentication system that can accurately authenticate users by determining whether an intention of use is present, without imposing a burden on the users.

In addition, the invention aims to provide a room entry/exit management system using such a user authentication system.

A user authentication system relevant to the present invention includes: a first wireless tag having first ID data about a user and a first antenna for transmitting the first ID data; a second wireless tag having second ID data different from the first data, and a second antenna, disposed perpendicularly to the first antenna, for transmitting the second ID data; a wireless-tag receiver for receiving the first ID data transmitted from the first antenna and the second ID data transmitted from the second antenna; and a use-permission determining means for determining whether the ID data received by the receiver matches pre-registered ID data, and for determining, based on timing of or counts of receptions of the first ID data and the second ID data received during a predetermined period of time, whether use is permitted.

According to the invention, there is a benefit in that user authentication can be performed accurately without forcing the user special operations such as holding up an IC card to a reader, or pressing a switch in order to express the intention of use.

In addition, because room exit/entry management is performed using such a user authentication system, it is made possible that the door is opened only for a user having an intention to enter the room, and the door is not opened for a user having no intention to enter the room.

### BRIEF DESCRIPTION OF THE DRAWINGS

FIG. 1 is a block diagram illustrating a user authentication system according to Embodiment 1 of the present invention.

FIG. 2 is a diagram illustrating a positional relationship between an RFID reader antenna and a tag antenna.

FIG. 3 is a diagram illustrating a positional relationship between the RFID reader antenna and the tag antenna.

FIG. 4 is a diagram illustrating actions and operations in the user authentication system according to Embodiment 1.

FIG. 5 is a diagram illustrating actions and operations in the user authentication system according to Embodiment 1.

### DETAILED DESCRIPTION OF THE PREFERRED EMBODIMENTS

### Embodiment 1

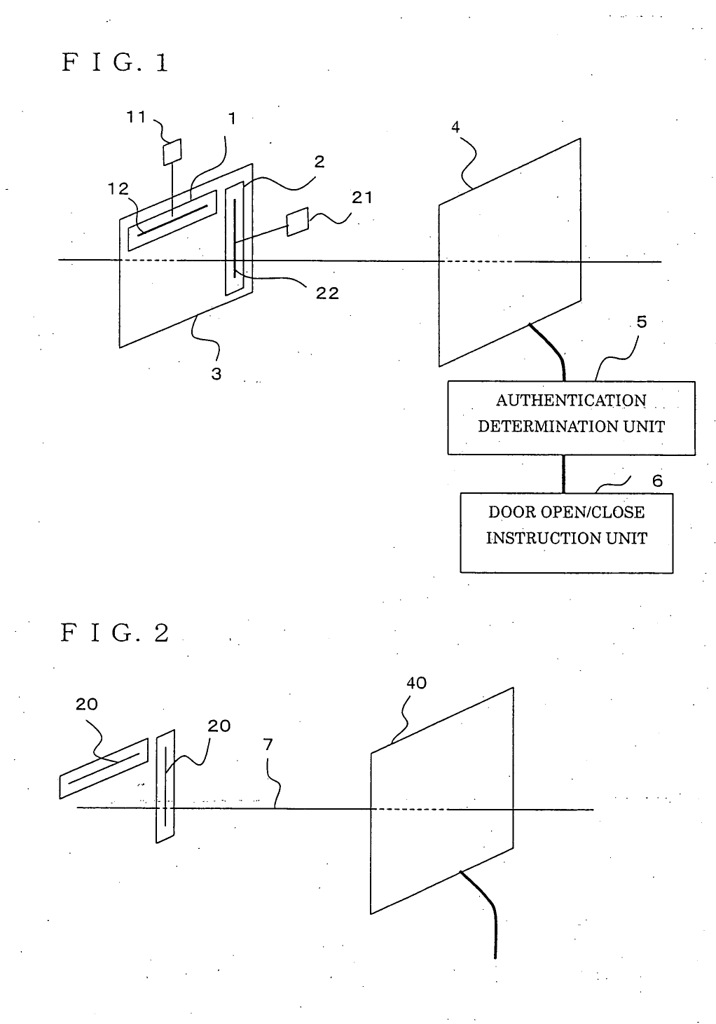

FIG. 1 is a block diagram illustrating a user authentication system according to Embodiment 1 of the present invention. Hereinafter, a case in which the user authentication system in the embodiment is used for room entry/exit management will be described, and an example in which a door is the object to which use-permission is given will be explained.

A user holds a tag plate 3, to which an RFID tag A (a first wireless tag) 1, and an RFID tag B (a second wireless tag) 2 are attached. The RFID tag A 1 and the RFID tag B 2 are composed of semiconductor chips (tag chips) 11 and 21, and tag antennas 12 and 22, respectively, and are disposed on the tag plate 3 so that the direction (axial direction) of the tag antenna 12 on the RFID tag A 1 (the first antenna) is perpendicular to the direction (axial direction) of the tag antenna 22 on the RFID tag B 2 (the second antenna). The tag plate 3 aims to keep the positional relationship between the RFID tag A 1 and the RFID tag B 2 constant. Each of the semiconductor chips 11 and 21 includes a memory that stores the user's ID code (ID data), and a communication control circuit for transmitting the ID code from each of the antennas 12 and 22. In addition, different ID codes are assigned to the ID code stored in the semiconductor chip 11 (first ID data) and the ID code stored in the semiconductor chip 21 (second ID data).

It is preferable to install a reader antenna (wireless-tag receiver) 4 in an RFID reader according to the embodiment, adjacent to the door for which permission to pass through is given, and to dispose the reader antenna so that the door face and the antenna surface of the reader antenna 4 are parallel to each other. The RFID reader antenna 4 receives ID codes transmitted from the RFID tag A 1 and the RFID tag B 2, in conformity to, for example, ISO/IEC18000-4 and ISO/IEC18000-6, and is preferable to have not a linearly-polarized radio emission characteristic, but a circularly-polarized radio emission characteristic.

An authentication determination unit 5 and a door open/close instruction unit 6 are connected to the reader antenna 4. The authentication determination unit (use-permission determining means) 5 determines whether the ID code in the RFID tag A 1 (first ID data) and the ID code in the RFID tag B 2 (second ID data) received by the RFID reader antenna 4 are pre-registered ID codes for which use-permission has been given, and determines, based on timing of receptions of the first ID code and the second ID code received during a predetermined period of time, whether use is permitted. More specifically, the use is permitted, only when the received first ID code and the received second ID code are ID codes for which use-permission has been given, and the first ID code and the second ID code are received together within a predetermined period of time. The door open/close instruction unit 6 opens the door when receiving a use-permission signal from the authentication determination unit 5.

Next, operations and actions in the user authentication system according to the present embodiment will be described in detail.

Firstly, characteristics of radio waves for RFID will be described. The radio frequency for ISO/IEC18000-4 is about 2.4 GHz, and the radio frequency for ISO/IEC18000-6 is about 900 MHz. Frequencies therearound are referred to as a microwave band. Radio waves are emitted from the RFID reader into space. The RFID tag receives the radio waves, and then transmits an ID code of the tag recorded in the tag chip. The RFID reader receives the ID code of the tag. RFID reader antennas 4 are grossly divided into two types of antennas. They are an antenna having a circularly-polarized wave characteristic, and an antenna having a linearly-polarized wave characteristic. Here, a case will be described in which rod antennas (dipole antennas as the most common antennas) are used for the antennas 12 and 22 for the tags, and a loop antenna having the circularly-polarized wave characteristic is used for the RFID reader antenna 4.

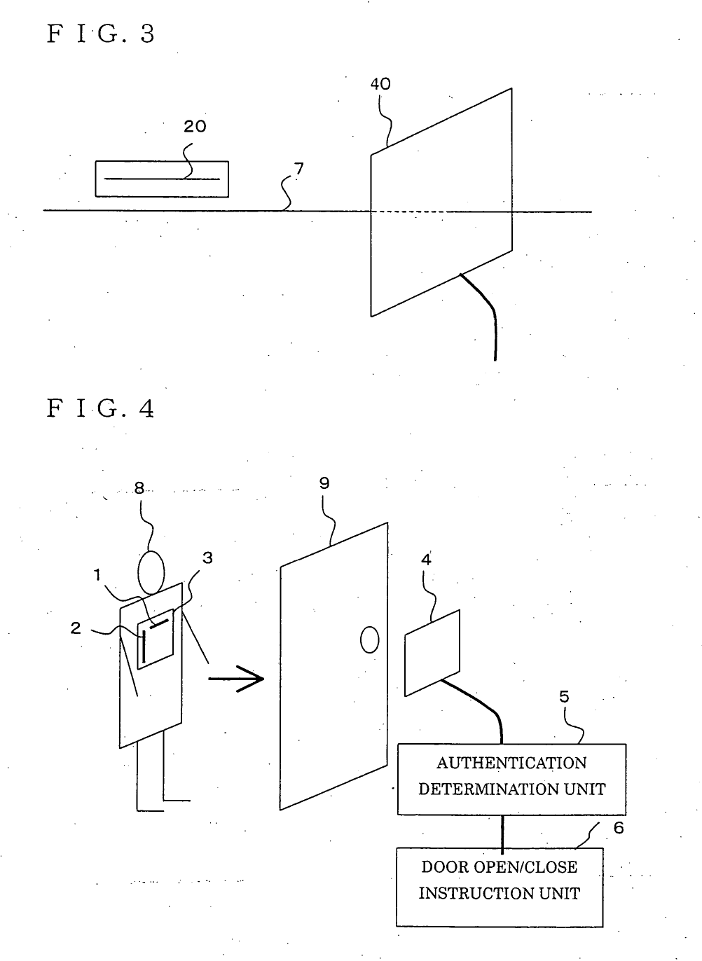

FIG. 2 and FIG. 3 are diagrams illustrating positional relationships between an RFID reader antenna 40 and a tag antenna 20. FIG. 2 shows an example of an arrangement in which the direction of the tag antenna 20 (axial direction) is perpendicular to an axis 7 that is perpendicular to the loop plane of the tag antenna 40 (axial direction of the RFID reader antenna 40). In this arrangement sensitivity of receiving radio waves in the reader antenna 40 is relatively high. FIG. 3 is an example of an arrangement in which the direction of the tag antenna 20 is parallel to the above-described axis 7. In this arrangement, the sensitivity of receiving radio waves is relatively low. For example, a case is present in which, when the direction of the tag antenna 20 is perpendicular to the axis 7, the maximum communicable range is 1 meter, and when the direction of the tag antenna 20 is parallel to the axis 7, the maximum communicable range is 20 centimeters. In this case, if the distance between the RFID reader antenna 40 and the tag antenna 20 is 50 centimeters, when the direction of the tag antenna 20 is perpendicular to the axis 7, an ID code of the tag can be read, and when it is parallel, the ID code of the tag cannot be read. The present embodiment utilizes the characteristic of radio waves.

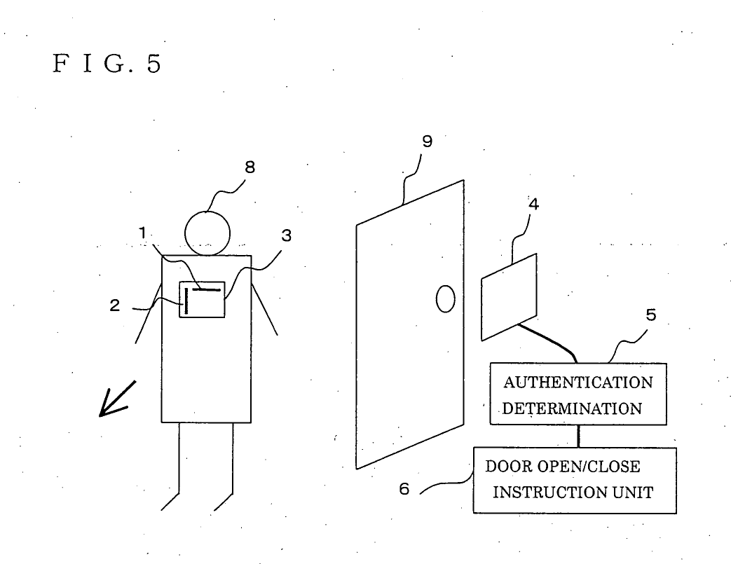

FIG. 4 and FIG. 5 are diagrams illustrating actions and operations in the user authentication system according to the embodiment. A user 8 wears a tag plate 3 on the front of the user's body. The tag plate can be, for example, pinned on the chest like a nametag, or dangled from the neck by a string being put therethrough.

FIG. 4 illustrates a case in which the user 8 is proceeding toward a door 9. An RFID reader antenna 4 is disposed adjacent to the door 9, parallel to the face of the door 9. When the user 8 wearing the tag plate 3 intends to enter the room or the like through the door 9, and is approaching the RFID reader antenna 4 adjacent to the door within a communicable range of ID transmission/reception via RFID, because the user 8 faces the door 9, the face of the tag plate 3 is perpendicular to the axial direction of the reader antenna 4. Consequently, the directions of the antenna 12 of the RFID tag A 1 and the antenna 22 of the RFID tag B 2 are both perpendicular to the axial direction of the reader antenna 4, and the RFID reader antenna 4 can receive both the ID code of the RFID tag A 1 and the ID code of the RFID tag B 2. Because the authentication determination unit 5 gives use-permission only when the ID code of the RFID tag A and the ID code of the RFID tag B are received together within a predetermined period of time, in the case of FIG. 4, the door can be opened by the door open/close instruction unit 6.

FIG. 5 illustrates a case in which the user 8 is passing in front of the door 9. When the user 8 does not intend to go through the door 9, and is passing in front of the door 9, even if the user 8 is approaching the RFID reader antenna 4 adjacent to the door within a communicable range of ID transmission/reception via RFID, the user 8 does not face the door 9. For this reason, the direction of the antenna 22 of the RFID tag B 2 is perpendicular to the axial direction of the reader antenna 4, but the direction of the antenna 12 of the RFID tag A 1 is not perpendicular to the axial direction of the reader antenna 4. Accordingly, the RFID reader antenna 4 can receive only one of the ID codes, of the RFID tag A 1 and of the RFID tag B 2 (in this case, the ID code of the RFID tag B 2). Because the authentication determination unit 5 gives use-permission only when the ID code of the RFID tag A and the ID code of the RFID tag B are received together within a predetermined period of time, in the case of FIG. 5, the door open/close instruction unit 6 never opens the door.

Moreover, because the user 8 wears the tag plate 3 with a pin, a string or the like, the tag plate sometimes turns around along the front of the body of the user, or flips over. However, even if the tag plate turns around along the front of the body of the user or flips over, when the user faces the RFID reader 4, both the antenna 12 of the RFID tag A 1 and the antenna 22 of the RFID tag B 2 are still perpendicular to the axial direction of the reader antenna 4, whereby the use-permission can be normally given.

Furthermore, when the user stands sideways with respect to the RFID reader antenna 4, because the antennas of the RFID tag A 1 and the RFID tag B 2 are not perpendicular to the axial direction of the reader antenna 4 at the same time, the use-permission is never given.

As described above, according to the embodiment, the use-permission is given only when the user faces the object to use. Therefore, the use-permission can be accurately given without forcing the user special operations such as switch operations for authentication.

### Embodiment 2

In Embodiment 1, the authentication determination unit 5 gives use-permission only when the ID code transmitted from the RFID tag A 1 and the ID code transmitted from the RFID tag B 2 are received together during a predetermined period of time. Generally, because an ID code is transmitted not just one time, but constantly, the identical ID code can be received many times during a predetermined period of time. When the RFID tag and the reader antenna are close to each other, and radio waves are strong, the count of receptions of the ID code during a predetermined period of time becomes large.

In the present Embodiment 2, the tag plate 3 and the reader antenna 4 are configured similarly to those in Embodiment 1 illustrated in FIG. 1, but the configuration of an authentication determination unit 5 is different, and the determination manner is different from that in Embodiment 1. More specifically, the authentication determination unit 5 gives use-permission, only when the ID code transmitted from the RFID tag A 1 and the ID code transmitted from the RFID tag B 2 are received together during a predetermined time, and the count of receptions of each of the received ID codes is not less than a predetermined value.

According to the determination described above, when the user faces the door, but is apart from the door, the door can be prevented from being opened. As a consequence, for example, when the user is walking toward the door, but the user does not intend to enter the room through the door, and the user goes around near the door, the door can be prevented from being opened, so that the use-permission can be given more accurately.

### Embodiment 3

In the present Embodiment 3, the tag plate 3 and the reader antenna 4 are configured similarly to those in Embodiment 1 illustrated in FIG. 1, but the configuration of an authentication determination unit 5 is different, and the determination manner is different from those in Embodiment 1 and Embodiment 2. More specifically, the authentication determination unit 5 is configured so as to count the ID code transmitted from the RFID tag A 1 and the ID code transmitted from the RFID tag B 2 every predetermined period of time, and to determine that the use is permitted, if the ID codes are received together during a predetermined period of time, and if the counts of receptions of the ID codes are not less than a predetermined count, and each ID-code reception count increases at each of predetermined intervals.

Configured as above, the use-permission is given, only when the user faces the object to use, the user is within a predetermined distance from the object to use, and the user is approaching the object to use. As a consequence, when although the user faces the door, the user is apart from the door, or is not approaching the door, the door can be prevented from being opened. For example, when the user is walking toward the door, but the user does not intend to enter the room through the door, and the user goes around near the door, the door can be prevented from being opened. In addition, when the user is near the door, but is not approaching the door, the door can be prevented from being opened, and the use-permission can be given more accurately.

### Embodiment 4

In the present Embodiment 4, the tag plate 3 and the reader antenna 4 are configured similarly to those in Embodiment 1 illustrated in FIG. 1, but the configuration of an authentication determination unit 5 is different, and the determination manner is different from those in Embodiment 1, Embodiment 2, and Embodiment 3. More specifically, the authentication determination unit 5 is configured so as to count the ID code transmitted from the RFID tag A 1 and the ID code transmitted from the RFID tag B 2 during a predetermined period of time, and to give use-permission, only when the sum of the count of receptions of the ID code of the RFID tag A 1 and the count of receptions of the ID code of the RFID tag B 2 during a predetermined period of time is not less than a predetermined value, and the difference between the count of receptions of the ID code of the RFID tag A 1 and the count of receptions of the ID code of the RFID tag B 2 during a predetermined period of time is not more than a predetermined value.

Even configured as above, when the user faces the door, but is apart from the door, the door can be prevented from being opened.

In addition, configured as above, the counts of receptions of the two ID codes are compared, and, in addition to the effects in Embodiment 1, more accurate authentication determination is made possible.

1. A user authentication system comprising:
a first wireless tag having first ID data about a user and a first antenna for transmitting the first ID data;
a second wireless tag having second ID data different from the first ID data, and a second antenna, perpendicular to the first antenna, for transmitting the second ID data;
a wireless-tag receiver for receiving the first ID data transmitted from the first antenna and the second ID data transmitted from the second antenna; and
use-permission determining means for determining whether the first ID data and the second ID data received by the wireless-tag receiver matches pre-registered ID data, and for determining, based on timing of or counts of receptions of the first ID data and the second ID data received during a predetermined period of time, whether use is permitted.

2. The user authentication device according to claim 1, wherein, if the first ID data and the second ID data are received together during the predetermined period of time, the use-permission determining means determines that use is permitted.

3. The user authentication device according to claim 1, wherein, if the first ID data and the second ID data are received together during the predetermined period of time, and counts of receptions of the first ID data and of the second ID data are not less than a predetermined number, the use-permission determining means determines that use is permitted.

4. The user authentication device according to claim 1, wherein, if the first ID data and the second ID data are received together during the predetermined period of time, counts of receptions of the first ID data and of the second ID data are not less than a predetermined number, and counts of each of the first ID data and the second ID data receptions increase at each of predetermined intervals, use-permission determining means determines that use is permitted.

5. The user authentication device according to claim 1, wherein, if the sum of a count of receptions of the first ID data and a count of receptions of the second ID data, received during the predetermined period of time, is not less than a predetermined value, and the difference between the count of receptions of the first ID-data reception and the count of receptions of the second ID-data reception count is not more than a predetermined value, the use-permission determining means determines that use is permitted.

6. A room entry/exit management system comprising a user authentication system according to claim 1.
